(19) United States
(12) Patent Application Publication
(10) Pub. No.: US 2012/0023136 A1
(43) Pub. Date: Jan. 26, 2012

(54) Matching Technology for Users of A Social Networking Site

(76) Inventors: Su-Chi Kuo, Taipei City (TW); Chia-Chi Kuo, Taipei City (TW)

(21) Appl. No.: 12/840,366

(22) Filed: Jul. 21, 2010

(51) Int. Cl. G06F 17/30

(52) U.S. Cl. 707/780; 707/E17.014; 707/769

(57) ABSTRACT

A matching technology for users of a social networking site contains an interface to set a matching module structure and build the matching module structure in a matching system, wherein the structure is comprised of at least one question database, a calculating and matching database, and a changing database, and the question database is used to receive an instruction from the matching module structure so as to acquire required questions, thereafter, the questions are calculated by the calculating and matching database so that a user adds or corrects the question by means of the changing database.

### BACKGROUND OF THE INVENTION

1. Field of the Invention

The present invention relates to a social networking site, and more particularly to a matching technology to find out someone who matches with a user.

2. Description of the Prior Art

With technology development, internet brings people another different virtual world, therefore many people enhance their personal charm, confidence, friends, and jobs from this virtual internet world, because they may be so shy and poor at speaking that they can not make friends in real life. However, how to apply virtual internet world to improve some shortages in real life, for example, making matched friends from internet to enhance social relationship, is an important question.

The present invention has arisen to mitigate and/or obviate the afore-described disadvantages.

### SUMMARY OF THE INVENTION

The primary object of the present invention is to provide a matching technology for users of a social networking site that the user is capable of acquiring association with the other users by answering questions, and each answer's dimension and score is used to find out the matched user to improve a mutual relationship between different people, thus enhancing people's social ability and confidence.

To obtain the above objective, a matching technology for users of a social networking site contains:

an interface to set a matching module structure and build the matching module structure in a matching system, wherein the structure is comprised of at least one question database, a calculating and matching database, and a changing database, and the question database is used to receive an instruction from the matching module structure so as to acquire required questions, thereafter, the questions are calculated by the calculating and matching database so that a user adds or corrects the question by means of the changing database.

### BRIEF DESCRIPTION OF THE DRAWINGS

FIG. 1 is a block diagram of a matching interface for users of a social networking site according to a preferred embodiment of the present invention;

FIG. 2 is a block diagram of a matching technology for the users of the social networking site according to the preferred embodiment of the present invention;

FIG. 3 is a block diagram showing steps of updating dimension scores and matching processes according to the preferred embodiment of the present invention;

FIG. 4 is a block diagram showing steps that a user checks the other users similar to him/her according to the preferred embodiment of the present invention;

FIG. 5 is a block diagram showing steps of adding or correcting questions in a question database according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

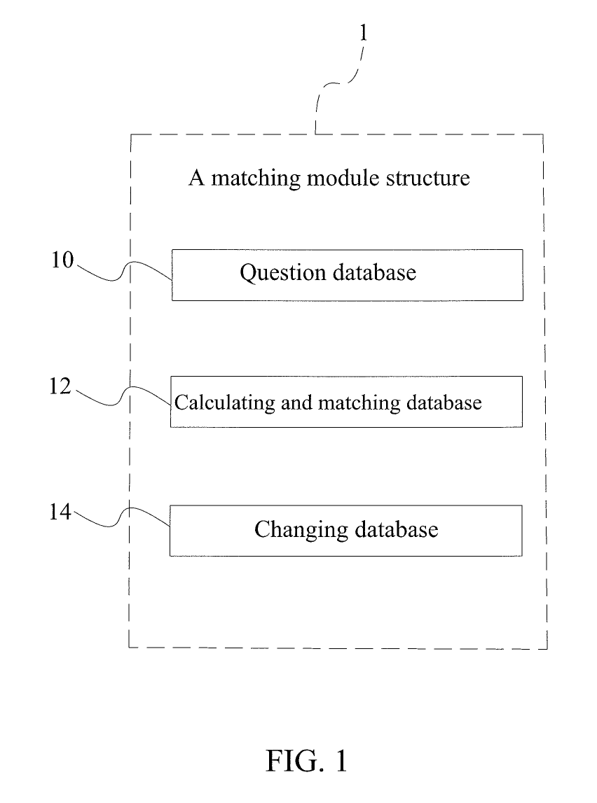

Referring to FIG. 1, a matching technology for users of a social networking site in accordance with a preferred embodiment of the present invention comprises an interface to set a matching module structure 1 and build the matching module structure in a matching system, wherein the structure is comprised of at least one question database 10, a calculating and matching database 12, and a changing database 14, and the question database 10 is used to receive an instruction from the matching module structure 1 so as to acquire questions, thereafter, the questions are calculated by the calculating and matching database 12 so that a user adds or corrects the questions by means of the changing database 14.

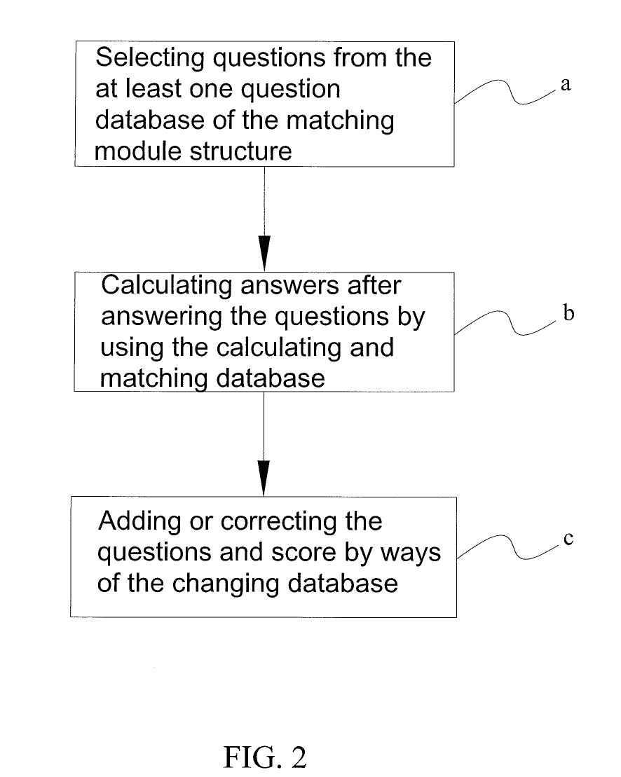

As shown in FIG. 2, the matching technology for the users of the social networking sites comprises steps of:

a. selecting questions from at least one question database 10 of the matching module structure 1;

b. calculating answers after answering the questions by using the calculating and matching database 12; and

c. adding or correcting the questions and score by ways of the changing database 14.

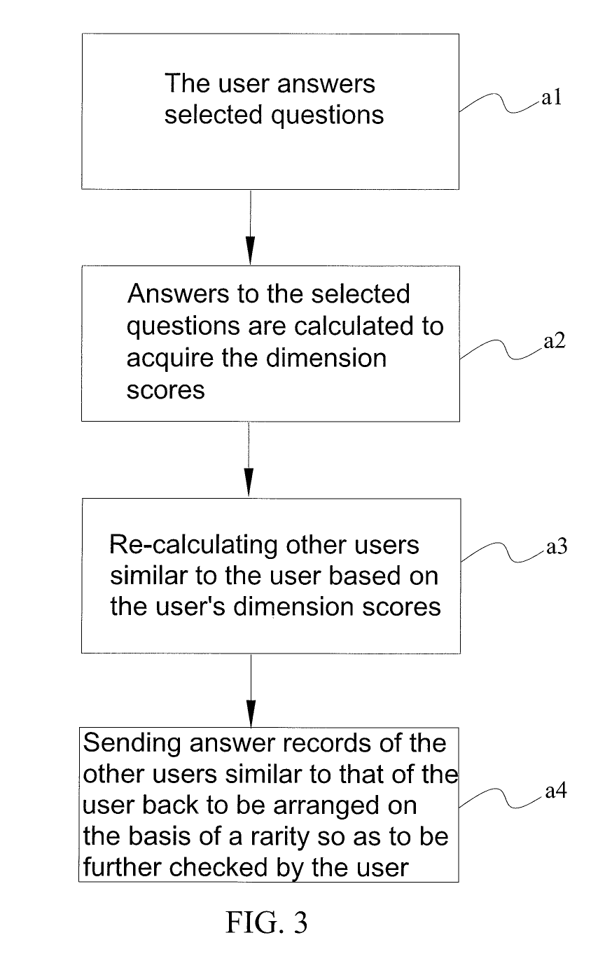

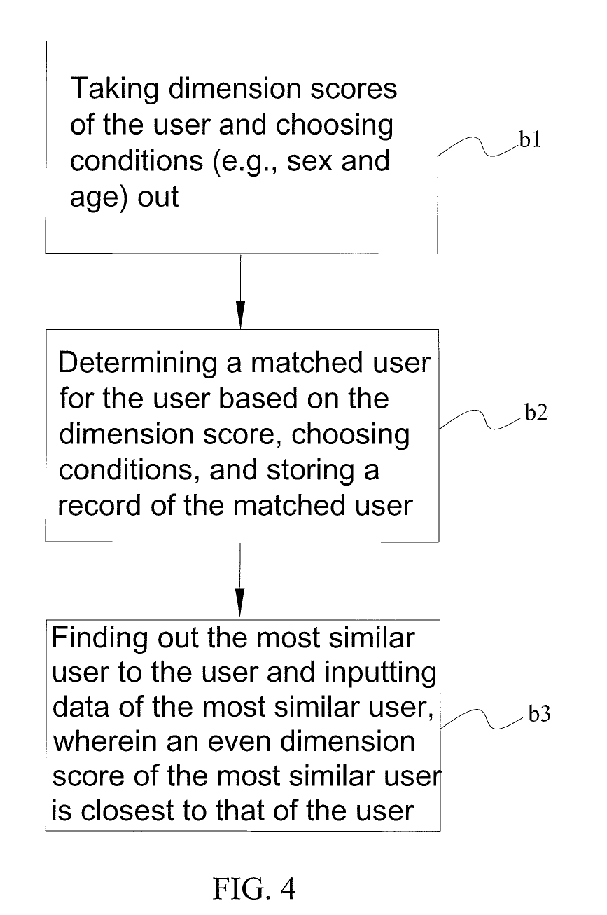

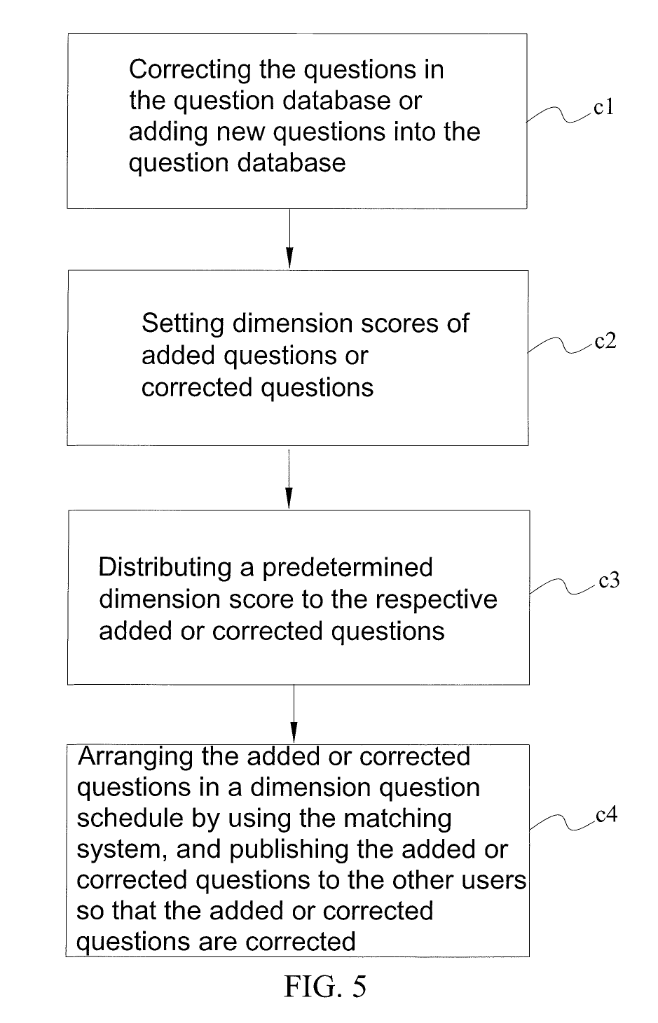

With reference to FIGS. 3-5, the step of a includes steps of updating dimension scores and matching processes; wherein

a1. the user answers selected questions;

a2. answers to the selected questions are calculated to acquire the dimension scores;

a3. re-calculating other users similar to the user based on the user's dimension scores; and

a4. sending answer records of the other users similar to that of the user back to be arranged on the basis of a rarity so as to be further checked by the user.

In other words, each user answers a series of questions (these questions are selected from the question database or added by the users, therefore when the matching system is generated, the questions are increased gradually, and a number of the questions are not fixed). The user probably answers different numbers of questions (for example, some patient users answer one hundred questions everyday, and the other users probably answer two or three questions sometimes), so this matching system is suitable for the users who answer different numbers of questions and different questions.

After answering the questions, the dimension score is calculated and matched, the user is checked with other similar users, and the checking steps include:

b1. taking dimension scores of the user and choosing conditions (e.g., sex, age, etc.) out;

b2. determining a matched user for the user based on the dimension score, choosing conditions, and storing a record of the matched user;

b3. finding out the most similar user to the user and inputting data of the most similar user, wherein an even dimension score of the most similar user is closest to that of the user.

When the user is desired to know which users are similar to him/her, all users in the networking site are filtered by a filter, for example, when the user is a male and he would like to choose someone who has the same sense of love with him, unmatched people are filtered based on a sexual limitation. Thereafter, matched people are compared and calculated the user's difference from even values of the matched people, and even differences of the user and the matched people are arranged from a smallest value to a largest value, and similar people to the user are arranged in a prior list.

Finally, the user is provided with information so that he knows the matched user who has similar sense of love as him after seeing answering record of the matched user. Therefore, when the matching system recognizes the user is similar to another user, it compares their answering records to conclude a connection between these two users.

After finishing selecting process, the user obtains the connection between the questions of the matched user and him/her so that the questions in the question database are added or corrected by the user, therefore steps of adding or correcting questions include:

c1. correcting the questions in the question database or adding new questions into the question database;

c2. setting dimension scores of added questions or corrected questions;

c3. distributing a predetermined dimension score to the respective added or corrected questions;

c4. arranging the added or corrected questions in a dimension question schedule by using the matching system, and publishing the added or corrected questions to the other users so that the added or corrected questions are corrected.

Thereby, the questions in the matching system are created by all users so that during answering the questions, the users are capable of adding questions, and added questions are classified in a certain dimension and each item and score of possible answer of the added question is added as well.

When answering one question, if the user thinks this question is not suitable, he/she allows to correct the question and the score of the answer, hence this matching system is feedbacked itself, and the number of the questions in the matching system are accumulated based on constant use.

By using above-mentioned steps and following examples, the matched user is found, wherein following seven dimensions are a comparison standard.

1. self centric degree;

2. outgoing degree;

3. mind degree;

4. active degree;

5. the luck with the opposite sex;

6. careless degree;

7. financial capability.

Above-mentioned dimension scores are quantified from 0 score to 10 scores. Taking the outgoing degree for example, 0 score means extreme shyness, yet 10 score denotes extreme outgoing. When two users are classified in a similar outgoing degree, the matching system can determine the two users have similar dimension in outgoing degree. The standards of the dimensions are different on the basis of desired searching purposes, when one user intends to find someone who is similar to him/her so as to make friends with each other, the dimension is different from another dimension used to find a similar lover.

A specific score of the dimension for each user is determined by asking the user a series of questions, and each dimension is classified in a certain range. For instance, the dimension of the outgoing degree is judged from the user's answer to following question:

If your friends invites you to have a party and you don't know anyone in the party, will you attend this party?

Answer A: Yes, I will be pleased to do so.

Answer B: Although I would not like to do that, I will force myself to attend that party.

Answer C: No, I will not attend that party.

Every question is classified in a certain dimension, and every answer is judged from 0 score to 10 scores. If the dimension of above-mentioned question belongs to outgoing degree, and Answers A, B, and C are judged in 10, 7, and 2 scores respectively, then the user who chooses the Answer A is determined as an outgoing person, while another user chooses the Answer C, then he is judged as a shy person. It is to be noted that the question and scores are created by the users.

In other words, each user answers a series of questions (these questions are created by all users so as to generate the matching system to accumulate various questions, therefore the questions in the question database are not fixed). Moreover, different users answer different numbers of questions individually, for example, some patient users answer one hundred questions everyday, and the other users probably answer two or three questions sometimes), accordingly this matching system is suitable for the users who answer different numbers of questions and different questions.

This technology is also used to solve following problems. In above-mentioned assumption, if two users answer all questions, their answers are compared and following problems happen:

(1). If the questions answered by the two users are different, the users are not compared.

(2). If only one question answered by the two users is the same, a comparison is not exact, because the users who choose Answers A and B have similar personality, but the two users have different personalities if they choose Answer A and C individually, therefore if only compare whether the answers to the questions are the same, a similarity between different items of questions do not reflect the similarity.

Accordingly, a multi-dimension question (such as there is limitless question in the matching system) is limited within a range (such as the self centric degree is limited within 7 dimensions) so that the users are compared within a dimension limitation to acquire the similarities but not be compared only based on a dimension comprised of all questions.

When the user answers enough questions (such as at least fifteen questions normally), a dimensional degree of the user is well understood (the more questions are answered, the more exact number is obtained). For instance, after the user answers fifteen questions, following records are achieved according to each question's dimension and answer's score.

Question 1: In dimension 1, score is 6;

Question 2: In dimension 2, score is 7;

Question 3: In dimension 3, score is 2;

Question 4: In dimension 4, score is 1;

Question 5: In dimension 5, score is 6;

Question 6: In dimension 6, score is 10;

Question 7: In dimension 7, score is 1;

Question 8: In dimension 1, score is 8;

Question 9: In dimension 2, score is 8;

Question 10: In dimension 6, score is 6;

Question 11: In dimension 4, score is 2;

Question 12: In dimension 8, score is 3;

Question 13: In dimension 6, score is 9;

Question 14: In dimension 7, score is 10;

Question 15: In dimension 1, score is 10.

By ways of above-mentioned record, an even score in every dimension of the user is concluded.

An even score of a first dimension (the Questions 1, 8, and 15 are first dimension) for this user is 8, e.g., (6+8+10)/3=8, so the even score of the first dimension is 8 located at a higher score range, it means this user has high self centric degree.

Because the user does not finish answering all questions within a specific time but after a long period of time (such as after a few days, months, more than one year), when he/she answers questions, his/her character and physical and mental state are not the same. Therefore, when determining every dimension, an adopted score is to add the even score of above-mentioned dimension and scores of a dimension of pervious five questions together to be further calculated their even score.

When the user answers many questions after a long period of time, a score weight of the questions currently answered is higher to react the user's current state. The score of each dimension is re-calculated after answering every question, hence the matching system re-calculates and updates the score of each dimension after the user answers every question.

For example, the matching system keeps updating the user's following records.

For user A:

Dimension 1: 7

Dimension 2: 5

Dimension 3: 8

Dimension 4: 5

Dimension 5: 1

Dimension 6: 3

Dimension 7: 9

Due to every user has such record, the matching system deals with comparison in accordance with everyone's score.

If final scores of each dimension of users A and B are

user A (7, 5, 8, 5, 1, 3, and 9)

user B (5, 6, 6, 6, 1, 6, and 6)

Each dimension of the user A is used to minus that of the user B, and then each difference is added together and then divided based on a number of item, thus obtaining an even difference.

For instance, a calculating method for above-mentioned example is (|7−5|+|5−6|+|8−6|+|5−6|+|1−1|+|3−6|+|9−6|)/7=1.71.

When an even difference between the two users becomes smaller, the matching system judges the two users are more similar.

When the user A is desired to know who is similar to him/her, the matching system deals with a filtering process by using the filter, for example, if the user A is a male and he intends to choose someone who has the similar sense of love as him, a sex is applied as a filtering limitation to delete unmatched users. Thereafter, matched users are compared, and even differences between the user A and the matched users are calculated and arranged from the smallest value to the largest values, wherein matched users arranged in the prior list are the more similar people to the user A.

Finally, the matching system will provide the user which user is most similar to him so that the user sees and knows the answer record of the questions, and the user feels this most similar user has the same emotion as him. Accordingly, when the matching system recognizes the user A and B are similar, it compares the answer records of the questions between the users A and B (because the questions answered by them are not the same, the connection between the questions is shown). For example, the users A and B may have following records.

Q1: the user A answers 1, and the user B answers 2

Q2: the user A answers 1, and the user B answers 1

Q3: the user A answers 3, and the user B answers 3

Q4: the user A answers 4, and the user B answers 3

Although in questions Q2 and Q3, the users A and B both choose the same answers, contents of the two questions Q2 and Q3 are not the same, and its explanation is shown as follows.

Q2: Do you have a pet dog of golden retrieve?

Ans. 1: Yes. (9 percentages of users choose this item)

Ans. 2: No. (91 percentages of users choose this item)

Q3: Which hardware is used by you to go on the internet?

Ans. 1: Cell phone (5 percentages of users choose this item)

Ans. 2: Desktop computer (30 percentages of users choose this item)

Ans. 3: Laptop computer (65 percentages of users choose this item)

For the user A, when he finds the user B have the same answer Ans. 1 to a question Q2, he feels more surprised than he finds the user B have the same answer Ans. 3 to a question Q3, because only 9 percentages of users choose an answer Ans. 1 to the question Q2, but there are 65 percentages of users choose the answer Ans. 3 to the question Q3. As far as the rarity is concerned, the user A hopes the user B also choose the answer Ans. 1 to the question Q2.

Therefore, when the user A intends to check information of the user B, the matching system arranges records based on the same answers of the users A and B and the rarity (e.g., the rarest answer is arranged foremost).

It is to be noted that all questions in the matching system are created by the users, and the users are capable of adding questions, then the added questions are classified into a certain dimension, added their answer items and scores. When the users answer the questions and think the selective answers are not good, they allow to correct the questions and the scores, so this matching system is feedback itself automatically and the number of the questions are allowed to be accumulated constantly.

Thereby, the user is capable of acquiring association with the other users by answering questions, and each answer's dimension and score is used to find out the matched user to improve a mutual relationship between different people, thus enhancing people's social ability and confidence.

While we have shown and described various embodiments in accordance with the present invention, it is clear to those skilled in the art that further embodiments may be made without departing from the scope of the present invention.

What is claimed is:

1. A matching interface for users of a social networking site being used to set a matching module structure and build the matching module structure in a matching system, wherein the matching module structure includes;
at least one question database to receive an instruction from the matching module structure so as to acquire questions;
a calculating and matching database to calculate the questions;
a changing database to add or correct the questions in the question database.

2. A matching technology for users of a social networking site comprising steps of:
a. selecting questions from the at least one question database of the matching module structure;
b. calculating answers after answering the questions by using the calculating and matching database;
c. adding or correcting the questions and score by ways of the changing database.

3. The matching technology for the users of the social networking site as claimed in claim 2, wherein the step of a further includes steps of updating dimension scores and matching processes; wherein
a1. the user answers selected questions;
a2. answers to the selected questions are calculated to acquire the dimension scores;
a3. re-calculating other users similar to the user based on the user's dimension scores;
a4. sending answer records of the other users similar to that of the user back to be arranged on the basis of a rarity so as to be further checked by the user.

4. The matching technology for the users of the social networking site as claimed in claim 2, wherein after answering the questions, the dimension score is calculated and matched, the user is checked with other similar users, and the checking steps include:
b1. taking dimension scores of the user and choosing conditions (e.g., sex and age) out;
b2. determining a matched user for the user based on the dimension score, choosing conditions, and storing a record of the matched user;
b3. finding out the most similar user to the user and inputting data of the most similar user, wherein an even dimension score of the most similar user is closest to that of the user.

5. The matching technology for the users of the social networking site as claimed in claim 2, wherein after finishing selecting process, the user obtains the connection between the questions of the matched user and him/her so that the questions in the question database are added or corrected by the user, therefore steps of adding or correcting questions include:
c1. correcting the questions in the question database or adding new questions into the question database;
c2. setting dimension scores of added questions or corrected questions;
c3. distributing a predetermined dimension score to the respective added or corrected questions;
c4. arranging the added or corrected questions in a dimension question schedule by using the matching system, and publishing the added or corrected questions to the other users so that the added or corrected questions are corrected.

6. The matching technology for the users of the social networking site as claimed in claim 5, wherein dimension score are quantified from 0 score to 10 scores.
